(19) United States
(12) Patent Application Publication
(10) Pub. No.: US 2009/0169069 A1
(43) Pub. Date: Jul. 2, 2009

(54) Apparatus for Inputting Optical Data Using Optical Fiber

(75) Inventors: Yoon-Soo Kim, Seoul (KR); Ki-Cheol Wang, Gyeonggi-do (KR); Kyu-Chea Jung, Chungcheongnam-do (KR)

Correspondence Address: INTELLECTUAL PROPERTY LAW GROUP LLP, 12 SOUTH FIRST STREET, SUITE 1205, SAN JOSE, CA, 95113, US

(73) Assignee: YOU & ME CO., LTD., Seongnam-si, Gyeonggi-do (KR)

(21) Appl. No.: 12/067,043

(22) PCT Filed: Sep. 14, 2006
(86) PCT No.: PCT/KR2006/003653

§ 371 Date: Sep. 5, 2008

(30) Foreign Application Priority Data
Sep. 15, 2005 (KR) 10-2005-0086160

(51) Int. Cl. G06K 9/00; G06K 7/10; G06F 3/033

(52) U.S. Cl. 382/124; 382/321; 345/166

(57) ABSTRACT

Disclosed herein is an apparatus for inputting optical data. The optical data input apparatus includes an image sensor, a bundle of optical fibers, and a light emission device. One end surface of the bundle of optical fibers is arranged close to the image sensor, and the other end surface of the bundle of optical fibers is arranged close to an image acquisition surface. The light emission device radiates light onto the image acquisition surface. The end surface (light receiving surface) of the bundle of optical fibers, which is arranged close to the image acquisition surface, is spaced apart from the image acquisition surface. Optical signals radiated by the light emission device are radiated to a space between the image acquisition surface and the light receiving surface, are reflected or scattered on the image acquisition surface, and are received by the bundle of optical fibers.

### TECHNICAL FIELD

The present invention relates to an apparatus for inputting optical data using optical fiber and more specifically, to an apparatus for inputting optical data of which the thickness can be reduced by minimizing the spacing between the image acquisition surface and the image sensor and the size of an image forming device. Also, the present invention relates to a mouse, a fingerprint identification apparatus and a scanning apparatus with improved portability and convenience by minimizing the size of an image forming device.

### BACKGROUND ART

In general, an optical pointing apparatus or optical scanning apparatus using an image sensor refers to an apparatus, in which light radiated by a light emission device is reflected from an image acquisition surface, the reflected light is detected by an image sensor, the signals of the detected light are analyzed, and a location is designated on a graphic user interface, such as a computer screen, or the signals are stored and represented as an image. The optical pointing apparatus or optical scanning apparatus may have a similar optical image input structure so as to acquire images.

FIG. 1 is a conceptual view of a conventional optical data input apparatus.

Referring to FIG. 1, the conventional optical data input apparatus includes a light emission device 101, an image acquisition surface 102, an image forming device 103, an image sensor 105, a control unit 107, and a calculation unit 109. The optical data input apparatus has a structure that can be generally applied to an optical scanning apparatus and an optical pointing apparatus.

The light emission device 101 is a device for radiating light onto the image acquisition surface 102. In general, a laser diode, a Light Emitting Diode (LED), or a lamp may be used as the light emission device 101.

The image acquisition surface 102 is a surface from which light radiated by the light emission device 101 is reflected. The image acquisition surface 102 may be an external reflective surface from which light radiated by the light emission device 101 is reflected. In general, the image acquisition surface 102 may be a scanning surface in the case of a scanning apparatus, and may be a support surface, on which a mouse is placed, in the case of a mouse. The image acquisition surface 102 is preferably a surface parallel to the bottom of the optical data input apparatus so that the optical data input apparatus can achieve uniform resolution. Otherwise, a transparent thin plate may be inserted between the optical data input apparatus and the image acquisition surface 102 so as to ensure distance for the light radiated from the light emission device 101.

The image forming device 103 serves to focus light, reflected from the image acquisition surface 102, on the image sensor 105. The light reflected from the image acquisition surface 102 is reflected in various directions depending on the curves and characteristics of the surface of an object. However, only when the light reflected from the image acquisition surface 102 is appropriately received by the image sensor 105 can the behavior of the light be detected by the image sensor 105. Accordingly, a device that functions to correct the path of the light reflected on the image acquisition surface 102 is required. The device that performs such a function is the image forming device 103.

A convex lens may be generally used as the image forming device 103.

The image sensor 105 serves to convert light energy into electrical energy when light is focused by the image forming device 103. By processing signals, that is, the electrical energy acquired by the image sensor 105, various digital apparatuses, including the optical data input apparatus, can analyze and process images.

The control unit 107 is an element that controls the optical data input apparatus. The control unit 107 serves to correct images acquired by the image sensor 105, and to make the intensity of light uniform, thereby converting images into digital signals.

The calculation unit 109 serves to calculate a pointing location displayed by the optical data input apparatus, or to reconstruct the converted image signals, using the movement of the image, based on the image corrected by the control unit.

Since the above-described conventional optical data input apparatus uses a lens as the image forming device, the conventional optical data input apparatus has a disadvantage in that the distance between the image acquisition surface and the image forming device cannot be reduced to a certain distance. That is, in the above-described structure, a certain distance is required between the image acquisition surface and the image forming device for reasons related to the thickness of the lens used as the image forming device and the focal distance of the lens. When the distance is reduced, images may be distorted.

In the above case, the image sensor and the image forming device are generally manufactured separately, therefore there is a limitation in considerably reducing the thickness of the optical data input apparatus due to the distance between the image sensor and the image forming device and the distance between the image forming device and the image acquisition surface.

### DISCLOSURE OF THE INVENTION

### Technical Problem

Accordingly, the present invention has been made keeping in mind the above problems occurring in the prior art, and an object of the present invention is to provide an optical data input apparatus that can minimize the spacing between the image acquisition surface and the mage sensor.

Another object of the present invention is to provide an optical data input apparatus, in which the size of an image forming device is minimized, so the thickness thereof can be significantly reduced.

Still another object of the present invention is to provide a mouse having significantly improved portability and convenience, in which the size of an image forming device is minimized.

Still another object of the present invention is to provide a fingerprint identification apparatus having significantly improved portability and convenience, in which the size of an image forming device is minimized.

Still another object of the present invention is to provide a scanning apparatus having significantly improved portability and convenience, in which the size of an image forming device is minimized.

### Technical Solution

In order to accomplish the above object, the present invention provides an apparatus for inputting optical data, including an image sensor; a bundle of optical fibers, one end surface of the bundle of optical fibers being arranged close to the image sensor and the other end surface of the bundle of optical fibers being arranged close to an image acquisition surface; and a light emission device for radiating light onto the image acquisition surface; wherein the end surface (light receiving surface) of the bundle of optical fibers, which is arranged close to the image acquisition surface, is spaced apart from the image acquisition surface, and optical signals radiated by the light emission device are radiated into a space between the image acquisition surface and the light receiving surface, are reflected or scattered on the image acquisition surface, and are received by the bundle of optical fibers.

In a preferred embodiment of the present invention, the end surface (light receiving surface) of the bundle of optical fibers, which is arranged close to the image acquisition surface, is inclined relative to the image acquisition surface. The light receiving surface of the end of the bundle of optical fibers, which is arranged close to the image acquisition surface, is inclined at an angle in a range from 3 to 10 degrees with respect to the image acquisition surface. The angle between the light emission device and the image acquisition surface is greater than an angle between the light receiving surface and the image acquisition surface. The light radiated by the light emission device is parallel light. The light emission device comprises a laser diode. The light emission device comprises a Light Emitting Diode (LED), and a shielding film placed outside the LED. The image sensor converts optical signals into electrical signals. The image sensor is formed by directly attaching a bare chip, constituting part of the image sensor, to a printed circuit through wiring bonding. The image sensor is formed by directly attaching a bare chip, constituting part of the image sensor, to a printed circuit through flip-chip bonding.

According to another aspect of the present invention, there is provided an optical mouse apparatus having an image acquisition surface, a light emission device, image sensor and a bundle of optical fibers, wherein one end surface (light receiving surface) of the bundle of optical fibers, which is arranged close to the image acquisition surface, is spaced apart from the image acquisition surface, and optical signals radiated by the light emission device are radiated into a space between the image acquisition surface and the light receiving surface, are reflected or scattered on the image acquisition surface, and are received by the bundle of optical fibers.

According to still another aspect of the present invention, there is provided a fingerprint identification apparatus having an image acquisition surface, a light emission device, image sensor and a bundle of optical fibers, wherein one end surface (light receiving surface) of the bundle of optical fibers, which is arranged close to the image acquisition surface, is spaced apart from the image acquisition surface, and optical signals radiated by the light emission device are radiated into a space between the image acquisition surface and the light receiving surface, are reflected or scattered on the image acquisition surface, and are received by the bundle of optical fibers.

According to still another aspect of the present invention, there is provided an optical scanning apparatus having an image acquisition surface, a light emission device, image sensor and a bundle of optical fibers, wherein one end surface (light receiving surface) of the bundle of optical fibers, which is arranged close to the image acquisition surface, is spaced apart from the image acquisition surface, and optical signals radiated by the light emission device are radiated into a space between the image acquisition surface and the light receiving surface, are reflected or scattered on the image acquisition surface, and are received by the bundle of optical fibers.

### ADVANTAGEOUS EFFECTS

According to the present invention, there is provided an optical data input apparatus that can minimize the spacing between the image acquisition surface and the mage sensor.

Furthermore, according to the present invention, the size of the image forming device is minimized, so the thickness of the optical data input apparatus can be significantly reduced.

Furthermore, according to the present invention, the size of the image forming device is minimized, so a mouse having significantly improved portability and convenience can be provided.

Furthermore, according to the present invention, the size of the image forming device is minimized, so a fingerprint identification apparatus having significantly improved portability and convenience can be provided. Furthermore, according to the present invention, the size of the image forming device is minimized, so a scanning apparatus having significantly improved portability and convenience can be provided.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### BRIEF DESCRIPTION OF THE DRAWINGS

FIG. 1 is a conceptual diagram of a conventional optical data input apparatus;

FIG. 2 is a diagram schematically illustrating an optical data input apparatus including an image forming device using optical fiber according to a preferred embodiment of the present invention;

FIG. 3 is a diagram schematically illustrating an optical data input apparatus including an image forming device using optical fiber having an inclined surface according to a preferred embodiment of the present invention;

FIG. 4 is a diagram illustrating only an image forming device according to a preferred embodiment of the present invention;

FIGS. 5 and 6 are diagrams schematically illustrating light emission devices according to preferred embodiments of the present invention;

FIG. 7 is a diagram illustrating an example of a fingerprint identification apparatus according to a preferred embodiment of the present invention; and

FIG. 8 is a diagram illustrating an example of a scanning apparatus according to a preferred embodiment of the present invention.

### BEST MODE FOR CARRYING OUT THE INVENTION

Hereafter, preferable embodiments according to the present invention will be described with reference to the attached drawings.

FIG. 2 is a diagram schematically illustrating an optical data input apparatus including an image forming device using optical fiber according to an embodiment of the present invention.

Referring to FIG. 2, the optical data input apparatus according to the present invention includes an image acquisition surface 201, an image forming device 203, a light emission device 205, an image sensor 207, a control unit 209 and a calculation unit 211. The optical data input apparatus has a structure that can be generally applied to an optical pointing apparatus and other optical data input apparatuses.

The image acquisition surface 201 is the surface from which the light radiated by the light emission device 205 is reflected. The image acquisition surface 201 may be an external reflective surface from which the light radiated by the light emission device 205 is reflected. In general, the image acquisition surface 201 may be a scanning surface in the case of a scanning apparatus, and may be a support surface, on which an optical mouse is placed, in the case of the optical mouse. The image acquisition surface 102 is preferably a surface parallel to the bottom of the optical data input apparatus so that uniform resolution can be maintained in the optical data input apparatus. Otherwise, a transparent thin plate may be inserted between the optical data input apparatus and the image acquisition surface 201 so as to ensure distance for the light radiated from the light emission device 205.

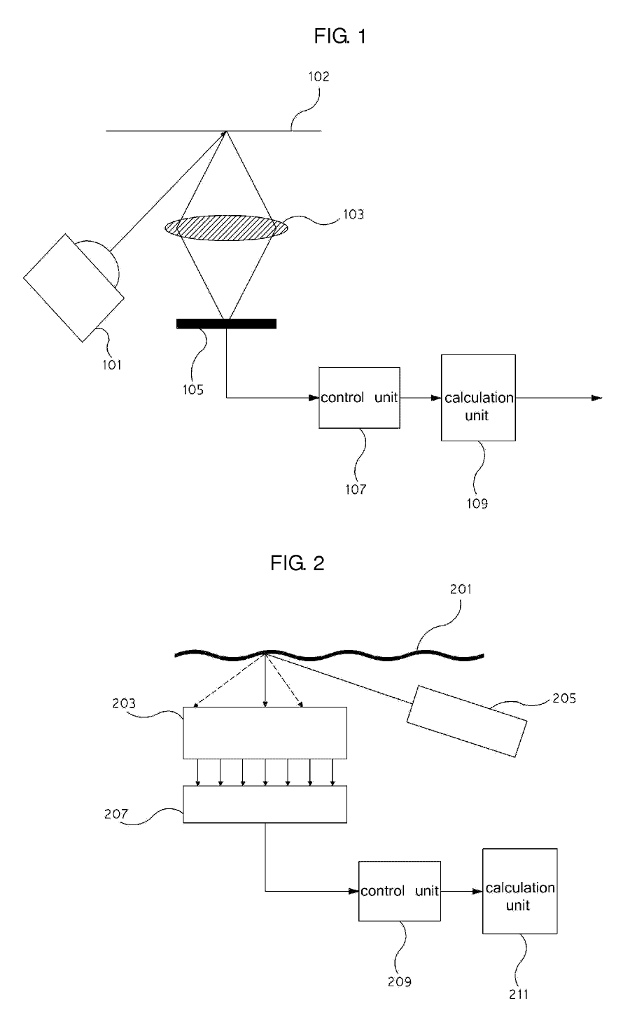

The image forming device 203 serves to focus the light, reflected from the image acquisition surface 201, on the image sensor 207. The image forming device 203 of the present invention can be formed to be considerably thin compared to the image forming device 103 illustrated in FIG. 1. The image forming device 203, which will be described in conjunction with FIG. 4 later, is formed of a thin bundle of optical fibers, and can appropriately receive the light, which is reflected from the image acquisition surface 201 at an angle at which an optical fiber can receive light, because the image forming device 203 is very close to the image acquisition surface 201. Furthermore, since the image forming device 203 is a bundle of optical fibers, the light, which is reflected from the image acquisition surface 201 and received by the image forming device 203, is transmitted to the image sensor 207 almost without loss.

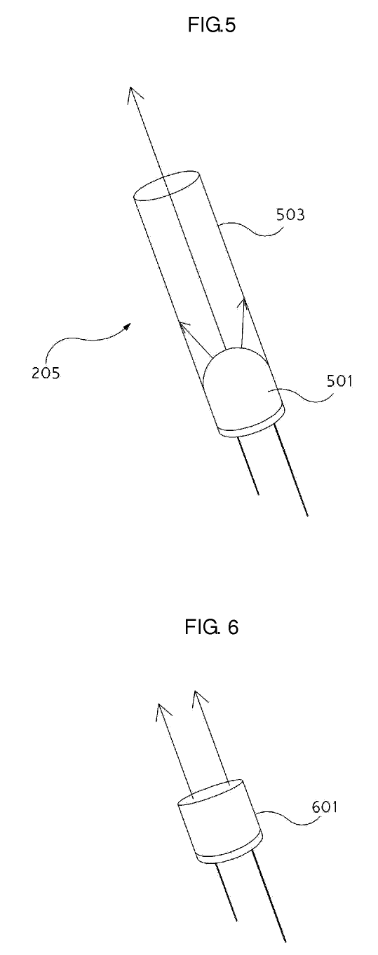

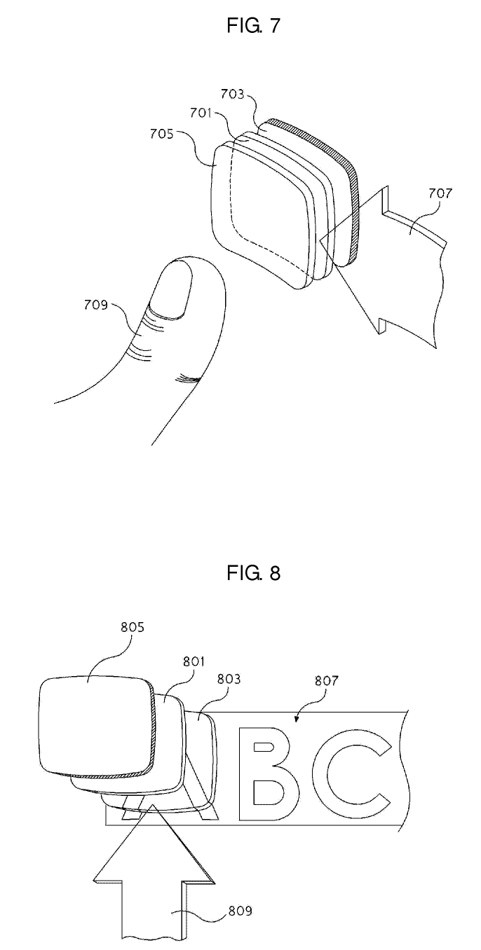

The light emission device 205 is a device that radiates light onto the image acquisition surface 201. In particular, the light emission device 205 according to the present invention must have the high parallelism of light, and must be formed to be thin compared to the conventional light emission device 101 because light must be radiated onto a space between the image acquisition surface 201 and the image forming device 203. The light emission device 205, which will be described in conjunction with FIGS. 6 and 7 later, may be formed by modifying a conventional LED or placing a shielding film outside an LED.

The image sensor 207 serves to convert light energy into electrical energy in response to light that has passed through the image forming device 203. By processing signals, that is, the electrical energy acquired by the image sensor 207, various digital apparatuses, including the optical data input apparatus, can analyze and process images.

Meanwhile, the image sensor 207 can be formed to be considerably thin compared to a conventional image sensor. Since the image forming device 203 can be formed of a considerably thin bundle of optical fibers, the image forming device 203 can be directly coupled to the image sensor 207. That is, the conventional image sensor generally has a structure in which a lead frame is connected to a bare chip and the lead frame and the bare chip are packaged using a molding compound. Accordingly, according to the structure of the conventional image sensor, the height of the optical data input apparatus must increase by the height of the lead frame and the packaging. However, in the present invention, a bare chip is directly connected to a Printed Circuit Board (PCB) through wiring bonding or flip-chip bonding, thus the height of the lead frame or packing can be reduced.

The control unit 209 is an element that controls the optical data input apparatus. The control unit 207 serves to correct images acquired by the image sensor 105, and to make the intensity of light uniform, thereby converting images into digital signals.

The calculation unit 211 serves to calculate a pointing location displayed by the optical data input apparatus, or to reconstruct the acquired image signals, using the movement of the image, based on the image corrected by the control unit.

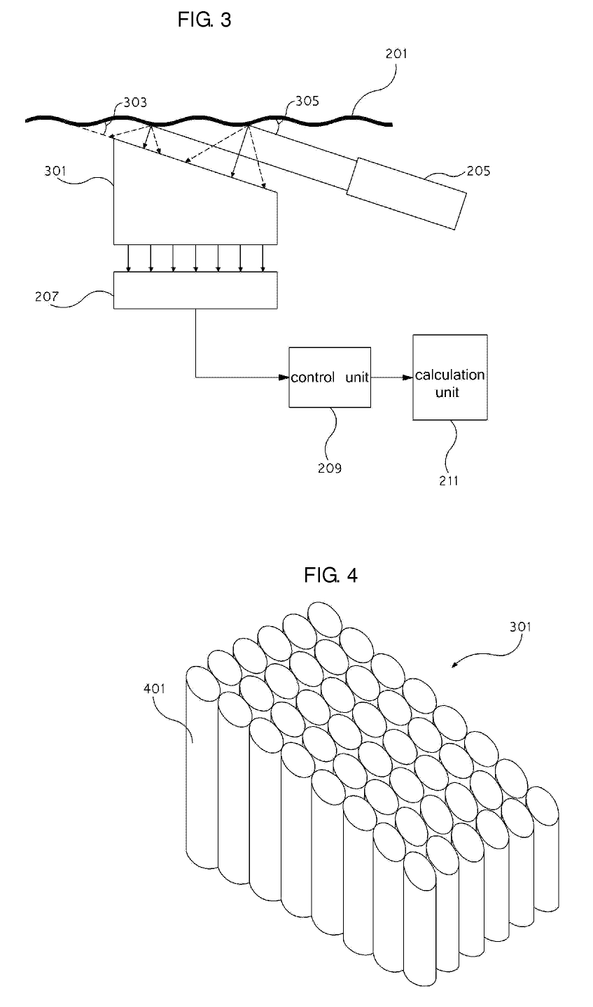

FIG. 3 is a diagram schematically illustrating an optical data input apparatus including an image forming device using optical fiber having an inclined surface according to a preferred embodiment of the present invention.

Referring to FIG. 3, the image forming device according to the present invention is different in structure from the image forming device of FIG. 2.

The function of the image forming device 301 is similar to that of the image forming device 203 of FIG. 2. That is, the image forming device 301 serves to focus the light, reflected from the image acquisition surface 201, on the image sensor 207.

However, the image forming device 301 is inclined to face the light radiated by the light emission device 205, and therefore has a structure that is capable of easily receiving the light radiated by the light emission device 205.

The above-described structure allows the image forming device 301 to be located close to the image acquisition surface 201, compared to the image forming device 203 of FIG. 2, and allows the image forming device 301 to easily receive the light radiated by the light emission device 205.

Meanwhile, the image forming device 301 having the above-described structure is at a specific angle 303 relative to the image acquisition surface 201. The angle 303 of the image forming device 301 is an angle suitable for receiving the light, which is radiated by the light emission device 205 onto the image acquisition surface 201 and is reflected from the image acquisition surface 201.

It is appropriate that the angle 303 of the image forming device be 5 degrees with respect to the image acquisition surface 201. The angle 303 may be adjusted to an angle between 3 and 10 degrees. This is an angle suitable for allowing the light, radiated by the light emission device 205, to be reflected from the image acquisition surface 201 while bringing the image acquisition surface 201 as close to the image forming device 301 as possible, so as to form the image forming device 301 and the image sensor 207 to be as thin as possible.

The angle 305 of the light emission device 205 is an angle that is necessary to radiate light to a space between the image forming device 301 and the image acquisition surface 201.

The light emission device 205, which will be described in detail in conjunction with FIGS. 5 and 6, has the characteristic in which radiated light is propagated straight in a direction based on the angle 305 of the light emission device 205 (parallel light), unlike the conventional light emission device. Since the light emission device 205 having the parallelism of light can directly radiate light onto the image forming device 301 according to the angle 305 relative to the image acquisition surface 201, it is preferred that the angle 305 be larger than the angle between the image forming device 301 and the image acquisition surface 201. Of course, even if the angle 305 is smaller than the angle 303 relative to the image forming device, light may not be directly radiated onto the image forming device 301 according to the location of the light emission device 205. Accordingly, it is appropriate that the angle 305 between the light emission device 205 and the image acquisition surface 201 be 3 to 12 degrees. The angle 305 may be adjusted to an angle in a range from 0 to 15 degrees according to the location of the light emission device 205.

In addition to the method of changing the angle of the light emission device, there may be a method of placing shielding films on the sides of the image forming device so that light can be prevented from being directly radiated onto the image forming device.

The above-described angles are all suitable for an optical pointing apparatus (optical mouse), and can be used in practice. However, the above-described angles are only an embodiment of the present invention, and are not intended to limit angles that can be expected within the scope of the present invention. Accordingly, angles, other than the above-described angles, which can be expected within the scope of the present invention, may be included in the scope of the present invention.

FIG. 4 is a diagram illustrating only an image forming device according to a preferred embodiment of the present invention.

Referring to FIG. 4, the image forming device 301 is a structure that is composed of a bundle of optical fibers 401 that are arranged in the same direction. The image forming device 301 is coupled to the image sensor on one surface thereof, and is brought close to the image acquisition surface on the opposite surface thereof.

The conventional image forming device generally has a lens structure to receive reflected and scattered light and transmit the light to the image sensor. The conventional image forming device has disadvantages in that the capacity for receiving light varies with the size of the lens and the distance to the image acquisition surface and the optical efficiency thereof is generally low.

In contrast, the image forming device 301 has a structure that is composed of the bundle of optical fibers 401. The bundle of optical fibers 401 is an optical wave guide, and has the characteristic of transmitting light that is incident within a specific angle with respect to the central axis of optical fibers constituting the bundle of optical fibers 401. In this case, the incident angle varies with the material and fabrication method of the optical fiber. Accordingly, the bundle of optical fibers 401 has the characteristic of not receiving light that is incident at angles each of which is larger than the specific angle relative to the central axis of the optical fiber. As a result, in the case where a subject, the image of which will be taken, is sufficiently close to the bundle of optical fibers 401, each optical fiber, included in the bundle of optical fibers 401, may form a single pixel.

Accordingly, the resolution of the image forming device 301 having the above-described structure is determined according to the spacing between the image acquisition surface 201 and the image forming device 301 and the characteristics of the optical fiber constituting the image forming device 201. As a result, the image forming device 301 according to the present invention can be brought maximally close to the image acquisition surface using the bundle of optical fibers 401, therefore the image forming efficiency of the image forming device is considerably improved compared to that of the conventional lens-type image forming device.

Furthermore, since the conventional image forming device uses a lens, it requires a certain distance between an image sensor and an image acquisition surface due to the focal distance of the lens. In contrast, since, in the image forming device 301 according to the present invention, each optical fiber can receive light reflected from an adjacent region and directly transmit the light to the image sensor, the distance between the image sensor and the image acquisition surface can be significantly reduced.

The image forming device 301 is somewhat inclined with respect to the image acquisition surface 201. Although the inclination of the image forming device 301 may be generally realized using a method of cutting the bundle of optical fibers 401 at an incline within a range that does not considerably impair the uniformity of the desired resolution, the inclination may be also realized using a method of inclining the arrangement of the bundle of optical fibers 401 itself.

It is appropriate that the angle of inclination be 5 degrees relative to the image acquisition surface. The angle of inclination may be in a range from 3 to 10 degrees according to the implementation. Since the angle is only an embodiment of the present invention, the angle may be appropriately selected within a range that is apparent to those skilled in the art.

The present embodiment is an embodiment which mitigates the disadvantage in which it is difficult for the light emission device 205 to radiate light onto the image acquisition surface 201 because the image forming device 301 according to the present invention is located very close to the image acquisition surface 201. In the image forming device 301 according to the present invention, the surface thereof close to the image acquisition surface is inclined, and thus light can be radiated to a space between the image acquisition surface and the image forming device without hindrance, therefore the resolution of the image forming device can be maintained in spite of the narrow spacing.

In the case of the image forming device 203 of FIG. 2 as well as the above-described inclined image forming device 301, an effect similar to that achieved in the inclined image forming device of FIGS. 3 and 4 can be achieved by adjusting the distance to the image acquisition surface 201 and the angle of the light emission device 205. Therefore, the image forming device of FIGS. 3 and 4 may be an optimal embodiment of the image forming device of FIG. 2.

FIGS. 5 and 6 are diagrams schematically illustrating light emission devices according to preferred embodiments of the present invention.

Referring to FIG. 5, the light emission device 205 has a structure in which a shielding film 503 is combined with an LED 501 that is used in the conventional light emission device. The shielding film 503 may be formed in a cylindrical shape to surround the LED 501, and may be made of material that absorbs light emitted from the LED 501 or prevent the transmission of the light. The shielding film 503 also acts as a reflective film, thus light having passed through the shielding film 503 propagates straight. In this case, the parallelism of light is not perfectly ensured by the shielding film 503, but the parallelism of light required over a limited distance in the present invention can be sufficiently achieved using the shielding film 503.

Referring to FIG. 6, another structure for maintaining the parallelism of light radiated by the light emission device 205 is illustrated. The light emission device 205 includes a truncated LED that has no hemispherical head, unlike the conventional LED. Since the modified LED 601 has no hemispherical head, unlike the conventional LED, the overall light radiated toward the front part of the modified LED 601 can propagate straight. Furthermore, light can be blocked by applying a light shielding paint or a simple shielding film to the side of the modified LED 601.

Furthermore, the modified LED of FIG. 6 may be combined with the shielding film structure of FIG. 5, and the modified LED combined with the shielding film structure may be used.

Besides the above-described structures, the cases of modifying an element, such as a laser diode, which is used in the light emission device, therefore the parallelism of light can be maintained, may be also included in the scope of the present invention.

Since the above-described structures of the light emission devices including shielding films are only embodiments of the present invention, the light emission device is not implemented using only the above-described methods. Although not shown in the drawings, the end surface of the shielding film may be formed in a shape identical to that of the image acquisition surface from which the radiated light is reflected. Furthermore, in order to achieve the prevention of the direct radiation of light onto the light forming device, which is the object of the attachment of the shielding film to the light emission device, an additional shielding film may be attached to the side of the image forming device.

FIG. 7 is a diagram illustrating an example of a fingerprint identification apparatus according to a preferred embodiment of the present invention.

Referring to FIG. 7, the fingerprint identification apparatus may be an embodiment in which the image forming device according to the present invention is used. The fingerprint identification apparatus may use the optical data input apparatus, and includes an image acquisition surface 705, an image sensor 703, and an image forming device 701 interposed therebetween.

In the fingerprint identification apparatus, when a user's fingerprint 709 is brought into contact with the image acquisition surface 705, the image forming device 701 transmits the fingerprint 709 to the image sensor 703 and the image sensor 703 constructs an image that is composed of electrical signals.

When the image forming device having the structure of FIG. 3 according to the present invention is used as the image forming device 701, the light 707 radiated in the lateral direction of the image forming device is radiated to and reflected on the image acquisition surface 705 and is received by the image forming device 701, therefore the thickness of the fingerprint identification apparatus can be considerably reduced compared to that of the conventional fingerprint identification apparatus.

FIG. 8 is a diagram illustrating an example of a scanning apparatus according to a preferred embodiment of the present invention.

Referring to FIG. 8, the scanning apparatus may be an embodiment in which the image forming device according to the present invention is used. The scanning apparatus uses the optical data input apparatus, and includes an image acquisition surface 803, an image sensor 805, and an image forming device 801 interposed therebetween.

In the scanning apparatus, while the scanning apparatus passes over images 807 on the surface of paper, respective images appearing on the image acquisition surface 803 are focused through the image forming device 801 and are scanned by the image sensor 805, thereby reconstructing the images. In order for the scanning apparatus to scan the images, appropriate illuminance must be ensured on the surface of the paper, therefore light 809 may be radiated through a side of the image forming device 801. If a plurality of such scanning apparatuses is coupled to each other, a scanning screen can be increased, so the function of a typical scanner can be implemented.

We claim:

1. An apparatus for inputting optical data, comprising:
an image sensor;
a bundle of optical fibers, one end surface of the bundle of optical fibers being arranged close to the image sensor and another end surface of the bundle of optical fibers being arranged close to an image acquisition surface; and
a light emission device for radiating light onto the image acquisition surface;
wherein the end surface (light receiving surface) of the bundle of optical fibers, which is arranged close to the image acquisition surface, is spaced apart from the image acquisition surface, and optical signals radiated by the light emission device are radiated to a space between the image acquisition surface and the light receiving surface, are reflected or scattered on the image acquisition surface, and are received by the bundle of optical fibers.

2. The apparatus as set forth in claim 1, wherein the end of the bundle of optical fibers (light receiving surface), which is arranged close to a bottom of the image acquisition surface, is inclined relative to the image acquisition surface.

3. The apparatus as set forth in claim 2, wherein the light receiving surface is inclined at an angle in a range from 3 to 10 degrees with respect to the image acquisition surface.

4. The apparatus as set forth in claim 2, wherein the angle between the light emission device and the image acquisition surface is greater than an angle between the light receiving surface and the image acquisition surface.

5. The apparatus as set forth in claim 1, wherein the light radiated by the light emission device is parallel light.

6. The apparatus as set forth in claim 5, wherein the light emission device comprises a laser diode.

7. The apparatus as set forth in claim 5, wherein the light emission device comprises a Light Emitting Diode (LED), and a shielding film placed outside the LED.

8. The apparatus as set forth in claim 1, wherein the image sensor converts optical signals into electrical signals.

9. The apparatus as set forth in claim 1, wherein the image sensor is formed by directly attaching a bare chip, constituting part of the image sensor, to a printed circuit through wiring bonding.

10. The apparatus as set forth in claim 1, wherein the image sensor is formed by directly attaching a bare chip, constituting part of the image sensor, to a printed circuit through flip-chip bonding.

11. An optical mouse apparatus having an image acquisition surface, a light emission device, image sensor and a bundle of optical fibers, wherein one end surface (light receiving surface) of the bundle of optical fibers, which is arranged close to the image acquisition surface, is spaced apart from the image acquisition surface, and optical signals radiated by the light emission device are radiated into a space between the image acquisition surface and the light receiving surface, are reflected or scattered on the image acquisition surface, and are received by the bundle of optical fibers.

12. A fingerprint identification apparatus having an image acquisition surface, a light emission device, image sensor and a bundle of optical fibers, wherein one end surface (light receiving surface) of the bundle of optical fibers, which is arranged close to the image acquisition surface, is spaced apart from the image acquisition surface, and optical signals radiated by the light emission device are radiated into a space between the image acquisition surface and the light receiving surface, are reflected or scattered on the image acquisition surface, and are received by the bundle of optical fibers.

13. An optical scanning apparatus having an image acquisition surface, a light emission device, image sensor and a bundle of optical fibers, wherein one end surface (light receiving surface) of the bundle of optical fibers, which is arranged close to the image acquisition surface, is spaced apart from the image acquisition surface, and optical signals radiated by the light emission device are radiated into a space between the image acquisition surface and the light receiving surface, are reflected or scattered on the image acquisition surface, and are received by the bundle of optical fibers.
